(19) United States
(12) Patent Application Publication
(10) Pub. No.: US 2021/0086280 A1
(43) Pub. Date: Mar. 25, 2021

(54) Welding Electrode and Method for Electrically Welding a Ball

(71) Applicant: Bayerische Motoren Werke Aktiengesellschaft, Muenchen (DE)

(72) Inventors: Antonio BUDISELIC, Haag in OBB (DE); Maik HAMMER, Bruckberg (DE); Johann NIEKERK, Muenchen (DE)

(21) Appl. No.: 16/971,170

(22) PCT Filed: Mar. 22, 2019
(86) PCT No.: PCT/EP2019/057268

§ 371 Date: Aug. 19, 2020

(30) Foreign Application Priority Data
Apr. 20, 2018 (DE) 10 2018 206 074.6

(51) Int. Cl. B23K 9/08; B23K 9/24; B23K 35/02

(52) U.S. Cl. CPC B23K 9/08; B23K 2103/04; B23K 35/0261; B23K 9/24

(57) ABSTRACT

A welding apparatus includes a welding electrode, where the welding electrode has a concavely formed end-face region and where the welding electrode has a magnet such that a spherical dome-shaped portion of a magnetically attractable ball which is located in an effective range of the magnet is drawable against the concavely formed end-face region.

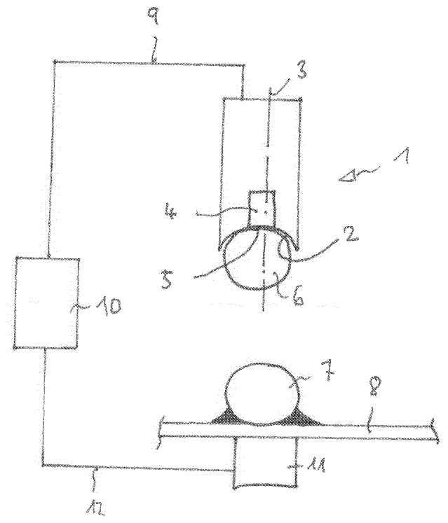

### BACKGROUND AND SUMMARY OF THE INVENTION

The present invention relates to a welding electrode and to a method for electrically welding a ball.

Methods for welding a ball to another component are sufficiently known, for example from DE 10 2014 218 968 B4 or DE 10 2014 205 609 B4 or DE 10 2014 200 551 B3.

The object of the invention is to provide a welding electrode with which the handling of a ball to be welded is made easier.

The starting point of the invention is a welding electrode, which is provided for welding balls, wherein the welding electrode has a concavely formed end-face region, which is suitable and/or intended for picking up a spherical dome-shaped portion of a ball to be welded.

An essential feature of the invention is that the welding electrode is provided or suitable and/or intended for welding magnetically attractable balls. The essence of the invention is that the welding electrode has at least one magnet, which is arranged such that a magnetically attractable ball to be welded, which is located in an effective range of the magnet (i.e., in the range of the magnetic field generated by the magnet), is drawn against an area that forms the concavely formed end-face region. The ball is therefore attracted by the magnet and automatically brought into a predefined position, i.e., centered with respect to the spherical dome-shaped portion.

The welding electrode may be a device that can be operated by hand, i.e., a hand welding electrode. As an alternative to this, it may also be a welding electrode attached to a robot arm. In both cases, it is of advantage with regard to the picking up and transporting of a ball to be welded if the latter is magnetically attracted.

The at least one magnet may be a permanent magnet. As an alternative to this, the at least one magnet may also be an electromagnet. If a number of magnets are provided, it is of advantage if they are arranged symmetrically with respect to a central longitudinal axis of the welding electrode. For example, three magnets may be provided, arranged at angular intervals of 120° with respect to one another around a central longitudinal axis (and at a distance from the central longitudinal axis) of the welding electrode. It is of advantage if the magnets are arranged such that magnetically attractable balls are always drawn into an exactly defined position with respect to the spherical dome-shaped portion of the welding electrode.

If a number of magnets are provided, one or more of the magnets may be permanent magnets and one or more of the magnets may be electromagnets. For example, a permanent magnet may be arranged centrally or in the middle and a number of (for example three) electromagnets may be arranged in a radial region with respect to a central longitudinal axis of the welding electrode.

The electromagnets may be switched on and off according to requirements. If the welding electrode is a welding electrode that can be operated by hand, there may be provided for example a switch that can be operated by hand, with which the magnet or the magnets can be switched on and off. It goes without saying that the magnets may also be switched on and off by a sensor system or an open-loop or closed-loop control system.

In the case of the method according to the invention for electrically welding a ball to another component, a welding electrode as described above is used. First, by means of such a welding electrode, a magnetically attractable ball, which may for example be a steel ball, is captured. “Capturing” means that the welding electrode is at least brought so close to the magnetically attractable ball that the latter is in the range of the magnetic field of the at least one magnet of the welding electrode and is attracted by the at least one magnet. The magnetically attractable ball consequently lies in a defined position against the spherical dome-shaped portion of the welding electrode.

Subsequently, the welding electrode is positioned such that the magnetically attractable ball is in its “target position”, i.e., in a position in which it is to be welded to the other component. The ball is in this case pressed against the other component by means of the welding electrode. For welding the ball to the other component, a welding current flowing through the ball is generated between the welding electrode and the other component. The welding current must be at least great enough that partial melting of the ball occurs in a region of contact with the other component.

Preferably, the welding current is fed into the ball via the concavely formed end-face region of the welding electrode or via the area of the welding electrode that forms the concavely formed end-face region.

As already mentioned, a steel ball may be used for example, since it is both electrically conducting and magnetically attractable.

By means of the method according to the invention and the welding electrode according to the invention, balls can be welded for example onto metal sheets or onto other balls. By means of the method according to the invention, a ball can be welded directly or indirectly to a vehicle component, such as for example a vehicle body component.

The invention is explained in more detail below in connection with the drawing.

### BRIEF DESCRIPTION OF THE DRAWING

The single FIGURE shows the basic principle of a welding electrode according to the invention in a schematic representation.

### DETAILED DESCRIPTION OF THE DRAWING

The FIGURE shows a welding electrode 1, which has a concavely formed end-face region 2. The welding electrode 1 has a central longitudinal axis 3. The welding electrode 1 also has a magnet 4, which is arranged in the middle or symmetrically with respect to the central longitudinal axis 3. An end face 5 of the magnet forms part of the concavely formed end-face region 2. However, this does not necessarily have to be the case. The magnet 4 may also be set back slightly. i.e., integrated further into the welding electrode 1.

A magnetically attractable ball 6 lies against the concavely formed portion 2. The ball 6 is attracted by the magnet 4. If the end face 5 of the magnet 4 forms part of the concavely formed end-face region, the ball 6 can lie directly against the end face 5 of the magnet 4. If the magnet 4 is set back further, i.e., is integrated further into the welding electrode 1, the ball 6 does not lie directly against the magnet 4.

The magnet 4 may be for example a permanent magnet. As an alternative to this, the magnet 4 may also be a switchable electromagnet.

By means of such a welding electrode, a ball can be simply “picked up”. For example, the welding electrode need only be held in a ball storage container, which has the effect that a ball “jumps” out of the ball storage container onto the welding electrode and is attracted by the magnet 4 such that the ball 6 is automatically “centered” with respect to the concavely formed end-face region.

After the picking up of the ball by means of the welding electrode 1, the ball 6 is brought or moved up to another component to which the ball 6 is to be welded. Here, the “other component” is a ball 7, which has been welded onto a metal sheet 8.

The welding electrode 1 is connected via a power line 9 to a welding unit 10, which generates an electrical welding voltage. In the case of the exemplary embodiment shown here, a second welding electrode 11 is provided, which is pressed from an underside of the metal sheet 8 against the metal sheet 8. The second welding electrode 11 is likewise connected to the welding unit 10 via an electrical line 12. When the ball 6 is pressed against the ball 7 and the welding unit is switched on, i.e., a welding voltage is applied, a welding current flows from the welding electrode 1 via the ball 6 to be welded, the ball 7, the metal sheet 8 and the welding electrode 11 back to the welding unit 10.

1.-11. (canceled)

12. A welding apparatus, comprising:
a welding electrode, wherein the welding electrode has a concavely formed end-face region and wherein the welding electrode has a magnet such that a spherical dome-shaped portion of a magnetically attractable ball which is located in an effective range of the magnet is drawable against the concavely formed end-face region.

13. The welding apparatus according to claim 12, wherein the magnet is a permanent magnet.

14. The welding apparatus according to claim 12, wherein the magnet is an electromagnet.

15. The welding apparatus according to claim 12, wherein the magnet is disposed symmetrically with respect to a central longitudinal axis of the welding electrode.

16. The welding apparatus according to claim 12, wherein the welding electrode has a plurality of magnets which are disposed symmetrically with respect to a central longitudinal axis of the welding electrode.

17. The welding apparatus according to claim 16, wherein the welding electrode has a permanent magnet disposed in a middle of the plurality of magnets and electromagnets disposed radially to the permanent magnet.

18. A method for welding, comprising the acts of:
capturing a magnetically attractable ball by the welding electrode of the welding apparatus according to claim 12;
pressing the magnetically attractable ball against a component; and
flowing a welding current from the welding electrode via the magnetically attractable ball to the component and partially melting the magnetically attractable ball in a region of contact with the component by the welding current.

19. The method according to claim 18, wherein the welding current flows into the magnetically attractable ball from the concavely formed end-face region of the welding electrode.

20. The method according to claim 18, wherein the magnetically attractable ball is a steel ball.

21. The method according to claim 18, wherein the component is a ball.

22. The method according to claim 21, wherein the ball is attached to a vehicle component or a vehicle body component.
